(19) United States
(12) Patent Application Publication
(10) Pub. No.: US 2004/0039697 A1
(43) Pub. Date: Feb. 26, 2004

(54) Procedure for the reliable preparation and execution of the financial settlement of a business transaction between a seller and buyer

(76) Inventor: Andras Vilmos, Budapest (HU)

Correspondence Address: SNELL & WILMER, ONE ARIZONA CENTER, 400 EAST VAN BUREN, PHOENIX, AZ, 850040001

(21) Appl. No.: 10/432,096

(22) PCT Filed: Nov. 9, 2001
(86) PCT No.: PCT/HU01/00109

(30) Foreign Application Priority Data
Nov. 20, 2000 (HU) P 0004604

(51) Int. Cl. G06F 17/60

(52) U.S. Cl. 705/40

(57) ABSTRACT

The present invention relates to a procedure for the reliable preparation and execution of the financial settlement of a business transaction between a seller and buyer, during which on the basis of the transaction agreement concluded between the seller and the buyer a payment data file is created containing primary payment information, the payment date file is forwarded to the buyer's mediation unit either directly or with the intervention of the buyer's IT device situated at the buyer, the payment data file is checked in the buyer's mediation unit, then following the check, depending on its result a balance transformation is carried out on the data of the financial unit in accordance with the payment data file, and passing the result of the balance transformation on to the seller's financial unit the financial settlement of the business transaction is carried out characterised by that during of following the business transaction concluded between the seller (10) and the buyer (130) creates a unique transaction identifying data member (11b) for the given business transaction, and the buyer (30) is informed of this, identified payment information (50) is created by supplementing the buyer's (30) primary payment information (41) with the unique transaction identifying data member (11b) that the buyer (30) was informed of, following this the identified payment information (50) is forwarded to the seller (10) with the help oc the buyer's IT device (31), through an information forwarding network (20), with the inclusion of the mediation unit (60) belonging to the buyer (30), through the mediation unit (70) belonging to the seller (10), and the financial settlement of the business transaction is initiated beside the forwarding of the identified payment information (50) or following this.

The subject of the invention relates to a procedure for the reliable preparation and execution of the financial settlement of a business transaction between a seller and a buyer, during which following or during the business transaction concluded between the seller and the buyer, the seller creates a unique transaction identifying data member for the given business transaction and the buyer is informed of this, furthermore, on the basis of the transaction agreement concluded between the seller and the buyer a payment data file is created containing primary payment information is created and we create a payment data file containing identified payment information by adding the unique transaction identifying data member that the buyer has been informed of to the buyer's primary payment information, the payment data file is forwarded to the buyer's mediation unit either directly or with the intervention of the buyer's IT device situated at the buyer, the payment data file is checked in the buyer's mediation unit, then following the check, depending on its result a balance transformation is carried out on the data of the financial unit in accordance with the payment data file, and passing the result of the balance transformation on to the seller's financial unit the financial settlement of the business transaction is carried out.

With the development of computing, information technology and telecommunications those business deals, in connection with the purchasing of services and goods, are gaining increasing ground in which the buyer and the seller do not meet each other in person, or if the personal meeting is realised the price of the purchased product or service is passed on from the buyer to the seller after the purchase is made as a result of some kind of bank transaction.

The patent description registered under number U.S. Pat. No. 6,014,636 relates to the realisation of a purchase during which it is not necessary for the buyer to be present at the scene of the purchase, instead the buyer is able to order the goods or service through a telecommunications network, in an interactive way. The disadvantage of the procedure, however, is that the buyer is obliged to settle the value of the goods essentially in advance by bank transfer so that the buyer has no guarantee that he/she will actually gain possession of the ordered product or service.

Another disadvantage is that such financial transactions taking place by bank transfer have caused numerous problems. In many cases those gaining unauthorised access to the identification data of the buyers withdraw smaller and larger sums from the bank accounts of the customers by carrying out unauthorised transfers, so causing losses for them.

Among others the procedure contained in the patent description registered under number HU P 98 02109 also makes an attempt to overcome such abuses. The essence of it is that before the performance of a transfer order to a bank account, the account-holding bank sends a request relating to the authorisation of a transaction by telecommunications network to the party who has authority over the account, who—also using a telecommunications device—send a confirmation message back. The bank, then, depending on the content of this authorisation message received via e.g. in an SMS carries out or rejects the request for the execution of the bank transfer.

The deficiency of this solution, however, is that although it places the buyer is such a circumstance that he/she may confirm the legitimacy of the fact of the transfer, neither the buyer nor the seller are assured that at the end of the business transaction the buyer will get the product ordered and the seller the money.

Such payment procedures also exist during which following the conclusion of the business transaction between the buyer and the seller the sending of the purchase price from the buyer to the seller is carried out with the assistance of a security organisation the task of which is to provide certain security identifiers to the transaction's seller and buyer and to check these identifiers during the procedure on one or more occasions before the financial transaction and during it. Such procedures can be seen in publication document No. WO 01/39062 and in patent declaration registration No. U.S. Pat. No. 6,029,150.

The disadvantage of the solutions is, however, that for the procedure to be realised both parties need to be in a contractual relation with an external security organisation—not playing a banking role in the financial performance—that plays a guaranteeing role between the buyer and the seller, who otherwise do not know each other. This intermediate contact-keeper does not create a unique transaction identifier serving to identify the transaction between the seller and the buyer, but an identifying code with which the parties certify their entitlement to participate in the transaction and their identity to each other and to the security organisation.

The disadvantage derived from this is that the business transactions between the sellers and the buyers may only be concluded in a restricted form, as electronic transactions, as the checking of the identifying codes requires significant technical apparatus. In the case that this procedure is applied, there is no possibility for direct purchasing, where the buyer wishes to purchase the product or service in person and wishes to pay the purchase price by transfer.

Another deficiency of these procedures is that the necessity for the security organisation increases the time required for the transaction, increases the amount of administration and with this the cost of the transaction, which is not desirable for either the buyer or the seller.

A further disadvantage is that due to the necessity for the security organisation the system that carries out the payments becomes closed as it is essential for the buyers and sellers participating in it to register themselves. This, on the one hand, however, makes it necessary for both the buyer and the seller to provide the security organisation with confidential information, which may, in a given case provide an opportunity for its misuse, and on the other hand, excludes the unrestricted, free application of the system and its expansion as required, as it restricts the group of possible sellers and buyers to those who have identifiers and who know each other's identifiers, others are excluded from the group of participants.

Another deficiency of these procedures is that the reception of the identifier codes issued by the security organisation, their interpretation and the composition and sending of the reply demands a static status due to the complex coding and data-transfer elements. This means that the participants registered at the security organisation may not change e.g. account-holding banks, computer, or only after going through a complex notification procedure, which is not good for technical development or for the economic and financial world, as it has a stagnating effect.

With the creation of the procedure according to the invention our objective was to increase the reliability of the known interactive purchases and to create a version where in the case of cash-free purchases both the seller and the buyer feel they have greater security—from both the points of view of possible abuses and the performance—, the confidential handling of the buyer's bank information remains, the seller receives quasi real-time information from its bank regarding the buyer's willingness to pay, and, however, the financial settlement of the business transaction, taking into consideration the points of view of security and economic, does not change as compared to the usual procedures.

We also set as an aim that the procedure should be applicable in the case of every imaginable business transaction, so not just only over the Internet or in the case of other different kind of so-called “remote buying”, but also in the case of business transactions taking place in person, where the actual settlement of the purchase price only takes place following the purchase, by bank transfer.

The basis of the idea of the invention was formed by the recognition that the fast telecommunications networks and information technology devices, as well as mobile communication devices of today make it possible for the seller to ascertain before the financial settlement of the business transaction and the delivery that the buyer really has the money for the ordered product or service and is also willing to pay. However, these same networks and devices greatly reduce the possibility for the seller or unauthorised person to acquire the buyer's identification data that would permit control over the buyer's bank account in any form.

The essence of the recognition is that the business transaction, in other words the buying process, and the financial settlement, in other words the actual payment of the purchase price, can be separated from one another, as during the business transaction a checking process may be inserted between the agreement and the payment in which—in the case that the appropriate technical conditions exist—the buyer's and the seller's banks may be included During the procedure, before the financial settlement an essentially real-time preliminary check may be realised between; the banks the result of which is also communicated to the seller also essentially real-time. And so with this solution the task may be solved.

Another aspect of the recognition is that on the conclusion of the business transaction the important confidentiality reliability elements are already available, so it is not necessar to create an organisation expressly for this purpose. As in the usual process of transfers there is already a trusting relationship established between the buyer and the buyer's bank and the same can be said of the relationship, between the seller and the seller's bank. Also, between the different banks there are numerous guarantee relationship based on contracts. So in the chain of organisations participating in the transaction, that is between two members of the buyer, buyer's bank, seller's bank, seller chain there is always a trusting relationship, which is important during financial performance, so in the case of suitably selected and clear identification of the transactions there is no need to introduce further organisations beside the usual four participants, so then with this solution the task can be solved.

In accordance with the set aim the procedure according to the invention for the reliable preparation and execution of the financial settlement of a business transaction between a seller and a buyer—during which following or during the business transaction concluded between the seller and the buyer, the seller creates a unique transaction identifying data member for the given business transaction, and the buyer is informed of this, furthermore, on the basis of the transaction agreement concluded between the seller and the buyer primary payment information a payment data file is created and we create a payment data file containing identified payment information by adding the unique transaction identifying data member that the buyer has been informed of to the buyer's primary payment information containing primary payment information, the payment data file is forwarded to the buyer's mediation unit either directly or with the intervention of the buyer's IT device situated at the buyer, the payment data file is checked in the buyer's mediation unit, then following the check, depending on its result a balance transformation is carried out on the data of the financial unit in accordance with the payment data file, and passing the result of the balance transformation on to the seller's financial unit the financial settlement of the business transaction is carried out—is based on the principle that during or following the business transaction concluded between the seller and the buyer the seller creates a unique transaction identifying data member for the given business transaction, and the buyer is informed of this, identified payment information is created by supplementing the buyer's primary payment information with the unique transaction identifying data member that the buyer was informed of, following this the identified payment information, free from any central identification of the data relating to the buyer and/or the seller, is forwarded to the seller with the help of the buyer's IT device, through an information forwarding network, with the inclusion of the mediation unit belonging to the buyer, through the mediation unit belonging to the seller, and the financial settlement of the business transaction is initiated beside the forwarding of the identified payment information or following this.

A further criterion of the procedure according to the invention may be that prior to the financial settlement of the business transaction, the identified payment information is passed on to the seller's turnover checking unit through the mediation unit belonging to the seller, there the identified payment information is examined again, and in this way confirmed payment information is created, and the financial settlement of the business transaction is only initiated following arrival of the confirmed payment information at the mediation unit belonging to the buyer.

In a possible realisation of the procedure prior to the financial settlement of the business transaction we create a, confirmation order with the help of the buyer's IT device situated at the buyer, the confirmation order is forwarded to the mediation unit belonging to the buyer, and the financial settlement of the business transaction is only initiated following this.

In a further, different version of the procedure the financial settlement of the business transaction is initiated at the same time as the identified payment information is passed on from the mediation unit belonging to the buyer to the mediation unit belonging to the seller.

In a still further inception of the invention the seller's unique transaction identifying data member is brought to the knowledge of the buyer with the help of the information forwarding network, and in a given case the unique transaction identifying data member is forwarded to the buyer's IT device situated at the buyer with the help of the information forwarding network.

Again in a different realisation of the procedure the unique transaction identifying data member is brought to the knowledge of the buyer directly.

In a further realisation of the procedure the transaction identifying data member is set in an identifying data file, and an individual transaction identifying data member of the identifying data file is linked to every individual business transaction.

It may be favourable from the point of view of the realisation of the invention that the mediation unit belonging to the buyer is the bank operating the buyer's financial unit and the mediation unit belonging to the seller is the bank operating the seller's financial unit, and in a given case the mediation unit belonging to the buyer and the mediation unit belonging to the seller are one and the same bank.

In a further version of the procedure the mediation unit belonging to the buyer and the mediation unit belonging to the seller are the same public utility service provider, and in a given case the financial unit belonging to the buyer and the financial unit belonging to the seller are both operated by the same public utility service provider.

The advantage of the procedure according to the invention is that with its application both the seller and the buyer can feel secure in the business transaction, as before the product is sent the seller has been able to ascertain that it will receive the price of the product, and the buyer does not have to provide information that would give unauthorised persons the opportunity to abuse it afterwards, what is more the buyer may acquire information regarding whether the transfer will actually arrive at the existing seller even before the financial settlement of the business transaction.

Another advantage of the procedure is that with simple means and without much development requirement it creates the secure conditions for electronic commerce, and so open the way for the widespread use of such business transactions, and for global economic development. Here we also have to note that the usability of the invention is helped especially by the increasingly common mobile communications devices.

Another favourable aspect is that in the majority of cases in order to execute the procedure it is not necessary to establish new technical devices, and frequently it is not even necessary to further develop them, nor install new devices at the buyers and the sellers, and so the application of the procedure does not require special investment, neither on the part of the buyer nor the seller.

In the following we present the procedure according to the invention in detail with the help of a drawing in connection with procedure examples. On the drawing

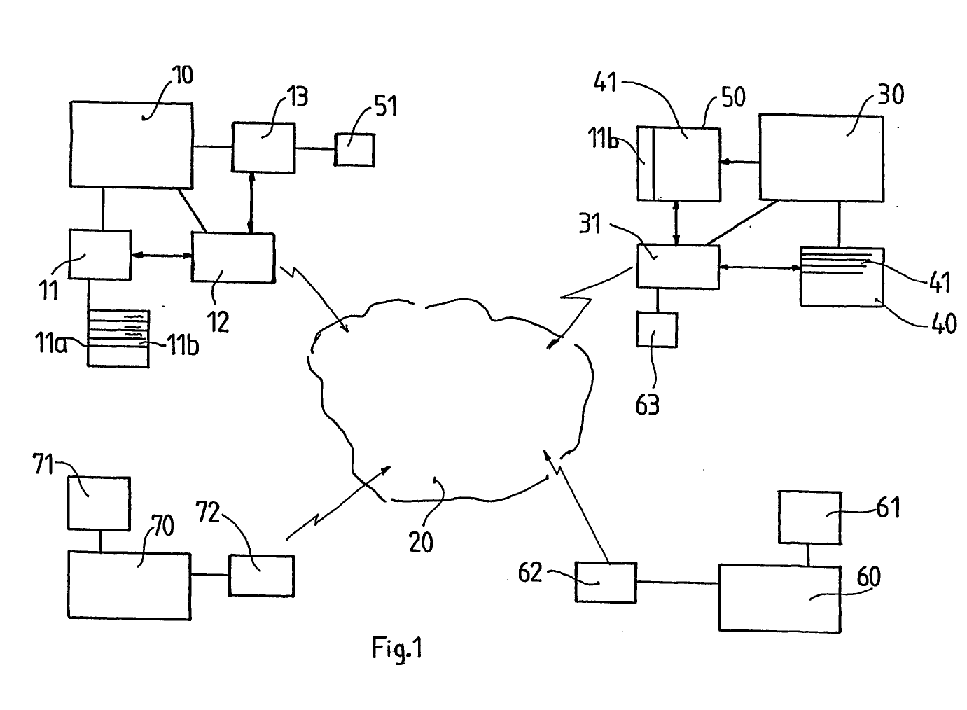

FIG. 1 shows a sketch of the connection of the network and the elements suitable for the procedure.

In FIG. 1 a possible arrangement can be seen with the help of which the procedure according to the invention can be executed. It can be observed that there is no direct connection between the seller 10 and the buyer 30. They get into contact with each other through an information forwarding network 20. The seller 10 connects to the information forwarding network 20 using the seller's IT device 12 and the buyer 30 using the buyer's IT device 31. Both the seller's IT device 12 and the buyer's IT device 31 may be some sort of computing device, interactive television, mobile device or some other device suitable for receiving and sending data and displaying it.

The seller 10 also has an identifier forming device 11 serving to create the identifier data file 11a containing the transaction identifying data member 11b and serving to store the transaction identifying data member 11b. Naturally the identifier forming device 11 may also be part of the seller's IT device 12. Also connected to the seller 10 is the turnover checking unit 13, which also may be part of the seller's IT device 12. Furthermore, the seller 10 has the mediation unit 70 serving to handle the financial unit 71, which mediation unit also has an IT unit 72.

Beside the buyer's IT device 31 the buyer 30 is also connected to the mediation unit 60 that operates the financial unit 61, which mediation unit 60 also has an IT unit 62. The seller 10 keeps in contact with the mediation unit 70 through the IT unit 72, and the buyer 30 has an information-forwarding link with the mediation unit 60 with the help of the IT unit 62. The link between the seller 10 and the mediation unit 70, and also between the buyer 30 and the mediation unit 60 may take place directly or also through the information forwarding network 20.

We have to note here that the term information forwarding network 20 is to be interpreted as a set of any devices operating and constructed in different ways that are suitable for carrying out communication. The same also applies to the link between the mediation unit 60 and the mediation unit 70, which may be solved by the direct linking of the IT unit 62 and the IT unit 72, or alternatively through the information forwarding network 20. However, in all the cases an important requirement is for the flow of information to be realised between the buyer 30 and the mediation unit 60, also between the mediation unit 60 and the mediation unit 70, and between the mediation unit 70 and the seller 10 with the appropriate amount of security.

It is practical if the mediation unit 60 is the buyer's 30 bank, and the financial unit 61 the current account held by the buyer 30 at the bank. The mediation unit 70 is the seller's 10 bank and, accordingly, the financial unit 71 is the seller's 10 current account. Here we must mention that it is not necessary for the mediation unit 60 and the mediation unit 70 to be banks, they may be other institutions, e.g. public utility service providers, and it is not necessary either for the financial unit 61 and the financial unit 71 to belong in an organisation sense to the mediation unit 60 and the mediation unit 70. It may also be imagined that either the mediation unit 60 belonging to the buyer 30 and the mediation unit 70 belonging to the seller 10 or the financial unit 61 belonging to the buyer 30 and the financial unit 71 belonging to the seller 10, or the whole group of them belong to the same bank or public utility service provider, in this way the communication between the mediation unit 60 and the mediation unit 70 and the flow of money takes place within one organisation.

In the following the procedure is presented with the help of examples of its inception.

### EXAMPLE 1

In this version of the procedure the business transaction takes place on the Internet. The buyer 30, with the help of the buyer's IT device 31, selects the product to be ordered and sends the order through the information forwarding network 20 to the seller's IT device 12 situated at the seller 10. The seller 10 generates a transaction identifying data member 11b with the help of the identifier forming device 11, which is also sent by the information forwarding network 20 to the buyer's IT device 31 situated at the buyer 30. Following making the order the buyer 30 creates the payment data file 40 containing the primary payment information 41, which contains all the data on the basis of which the buyers' 30 mediation unit 60 is able to identify the buyer 30 him/herself, the seller 10, the seller's 10 mediation unit 70 and the financial parameters of the transaction.

When the transaction identifying data member 11b has been communicated with the buyer's IT device 31 situated at the buyer 30, then the buyer 30 supplements the payment data file 40 containing the primary payment information 41 with the transaction identifying data member 11b received from the seller 10 and in this way creates identified payment information 50. The identified payment information 50 is now not only suitable for the clear determination of the seller 10, the mediation unit 70, and furthermore, the buyer 30, but it also has a piece of data serving to clearly identify the transaction established between the seller 10 and the buyer 30.

The identified payment information 50 created by the buyer 30 is now forwarded to the mediation unit 60 through the information forwarding network 20 with the help of the buyer's IT device 3i situated at the buyer 30. The mediation unit 60 is able to identify the buyer's 30 financial unit 61, in other words current account, on the basis of the received identified payment information 50, and on the basis of this to check whether the amount destined for the purchase is actually available to the buyer 30. In case the necessary amount of cover is available the mediation unit 60 sends the identified payment information 50 through the information forwarding network 20, practically with the appropriate data protection, to the mediation unit 70, which is the seller's 10 bank.

The mediation unit 70 identifies from the received identified payment information 50 the seller 10, and also its financial unit 71, in other words current account. Besides the identification the identified payment information 50 coming from the mediation unit 60 also provides a guarantee that the buyers' 30 financial unit 61 is able pay out the amount appearing in the identified payment information 50, and in relation to this serves as the promissory note, guarantee of the buyer's 30 mediation unit 60.

The identified payment information 50 that has arrived and been evaluated by the mediation unit 70 is forwarded through the information forwarding network 20 by the mediation unit 70 to the seller 10, which then compares the identified payment information 50 with the data it has using the turnover checking unit 13. If the data received in the identified payment information 50, especially the purchase price, conforms with the data stored in the seller's IT device 12 at the seller 10, then accepting that confirmed payment information 51 is created which the seller 10 then sends through its own mediation unit 70 to the buyer's 30 mediation unit 60, and also sends the product ordered by the buyer 30 to the buyer 30. After the confirmed payment information 51 has arrived back at the mediation unit 60—in the present version of the procedure—the mediation unit 60 also initiates the financial settlement related to the business transaction established between the seller 10 and the buyer 30. In accordance with this, in a way known in itself, a transfer transaction is carried out to the debit of the buyer's 30 financial unit 61, and in the usual way the amount transferred from the buyer 30 appears on the seller's 10 financial unit 71.

### EXAMPLE 2

In the present version of the procedure the seller 10 and the buyer 30 meet each other directly, in other words the business transaction does not take place through the information forwarding network 20, but in person. After the business transaction has been concluded the seller 10 issues an invoice to the buyer 30 that the seller's IT device 12 at the seller 10 prepares and prints out, additionally in such a way that the serial number of the invoice is the transaction identifying data member 11b generated by the identifier forming device 11. On the basis of the invoice received in this way the buyer 30 prepares the payment data file 40 that contains the primary payment information 41, also into which the transaction identifying data member 11b, in other words the serial number of the received invoice, is written directly. The created identified payment information 50 is sent to the mediation unit 60 with the help of the buyer's 30 mobile device.

The buyer's 30 mediation unit 60—in the way presented in the previous example—checks the identified payment information 50 and forwards it to the seller's 10 mediation unit 70, from where the information gets to the seller 10. On the basis of the received information the seller 10, following the conclusion of the business transaction, hands the goods over to the buyer 30 immediately at the scene.

### EXAMPLE 3

In the present version of the procedure the buyer 30 contacts the seller 10 through the information forwarding network 20 by telephone, and following concluding the business transaction the seller 10 issues an invoice which is a strictly numbered printed document coming from an invoice book. In the invoice book every single invoice contains a pre-printed serial number, which is the serial number of the given invoice, and which is prepared by the printing press that may be linked to the seller 10 as identifier forming device. All of the invoice numbers of the invoice book form the identifier data file 11a, while the individual invoice numbers form the transaction identifying data members 11b.

After the seller 10 has informed the buyer 30 of the invoice serial number relating to the transaction, in other words the transaction identifying data member 11b, the buyer 30 proceeds according to the way presented in example 1. The difference, however, is that when the seller 10 receives the identified payment information 50 from its mediation unit 70 and then following the check carried out in the turnover checking unit 13 the confirmed payment information 51 is created and returned to the mediation unit 60, the buyer's 30 mediation unit 60 does not initiate the financial settlement.

In this phase of the process the seller 10 has the appropriate guarantees that it will receive the price of the product to be supplied by it, but the buyer 30 has not yet been able to try out the ordered product. As a result of this the financial settlement is only initiated after the buyer 30 has received the ordered product and has sent a confirmation order 63 to the mediation unit 60 that the financial settlement may be, initiated.

On the basis of the examples presented it can be seen that the procedure according to the invention may have numerous other versions that may also be combined with each other, however, it is of basic importance in all of them that the buyer 30 does not inform the seller 10 of its bank identification data, instead the seller 10 creates a clear transaction identifying data member 11b that the buyer 30 may use independently, so in essence the buyer's 30 financial anonymity may remain during the business transaction and the financial settlement.

Another important new factor is that in essence the financial settlement is preceded by a real time payment promissory note, so the physical performance does not have to wait for the extended process of the financial settlement, even between partners that are unknown to one another. The feeling of comfort of the participants in the transaction is increased by the fact that they are only in contact with their own, known partners during the financial settlement of the whole transaction—the buyer and seller with their own mediation units, the mediation units with their own clients and with each other. The whole transaction is simplified by the fact that there is no need for the inclusion of an intermediate party with whom, otherwise, the participants in the transaction would not be in any contact!

In all the versions of the procedure according to the invention by sending the identified payment information to the seller's mediation unit the buyer's mediation unit can undertake a guarantee regarding the settlement of the purchase price appearing in the payment data file. This may also make it possible for the seller to speed up its cash flow, as in the possession of the bank promissory note it has the opportunity of selling the debt, if on the basis of the agreement the actual financial settlement only takes place at a later date.

The presented examples only relate to the main steps of the procedure according to the invention. During the actual realisation in order to satisfy the requirements of the clients to the utmost, however, it is practical to supplement the procedure with error and confirmation messages, and a process that processes refund requests. The present description does not extend to these services, as they may be derived from the principles and steps stated here.

The procedure according to the invention can be applied well especially for the fast and reliable execution of business transactions executed in electronic commerce.

1. A procedure for the reliable preparation and execution of the financial settlement of a business transaction between a seller and a buyer, during which following or during the business transaction concluded between the seller and the buyers the seller creates a unique transaction identifying data member for the given business transaction, and the buyer is informed of this furthermore on the basis of the transaction agreement concluded between the seller and the buyer a payment data file primary payment information is created and we create a payment data file containing identified payment information by adding the unique transaction identifying data member that the buyer has been informed of to the buyer's primary payment information containing primary payment information, the payment data file is forwarded to the buyer's mediation unit either directly or with the intervention of the buyer's IT device situated at the buyer, the payment data file is checked in the buyer's mediation unit, then following the check, depending on its result a balance transformation is carried out on the data of the financial unit in accordance with the payment data file, and passing the result of the balance transformation on to the seller's financial unit the financial settlement of the business transaction is carried out characterised by that during or following the business transaction concluded between the seller (10) and the buyer (30) the seller (10) creates a unique transaction identifying data member (11b) for the given business transaction, and the buyer (30) is informed of this, identified payment information (50) is created by supplementing the buyer's (30) primary payment information (41) with the unique transaction identifying data member (11b) that the buyer (30) was informed of, following this the identified payment information (50), free from any central identification of the data relating to the buyer and/or the seller, is forwarded to the seller (10) with the help of the buyer's IT device (31), through an information forwarding network (20), with the inclusion of the mediation unit (60) belonging to the buyer (30), through the mediation unit (70) belonging to the seller (10), and the financial settlement of the business transaction is initiated beside the forwarding of the identified payment information (50) or following this.

2. The procedure according to claim 1 characterised by that before the financial settlement of the business transaction, the identified payment information (50) is passed on to the seller's (10) turnover checking unit (13) through the mediation unit (70) belonging to the seller (10), there the identified payment information (50) is examined again, and in this way confirmed payment information (51) is created, and the financial settlement of the business transaction is only initiated following arrival of the confirmed payment information (51) at the mediation unit (60) belonging to the buyer (30).

3. The procedure according to claim 1 or 2 characterised by that before the financial settlement of the business transaction we create a confirmation order (63) with the help of the buyer's IT device (31) situated at the buyer (30), the confirmation order (63) is forwarded to the mediation unit (60) belonging to the buyer (30), and the financial settlement of the business transaction is only initiated following this.

4. The procedure according to claim 1 characterised by that the financial settlement of the business transaction is initiated at the same time as the identified payment information (50) is passed on from the mediation unit (60) belonging to the buyer (30) to the mediation unit (70) belonging to the seller (10).

5. The procedure according to any of claims 1-4 characterised by that the seller's (10) unique transaction identifying data member (11b) is brought to the knowledge of the buyer (30) with the help of the information forwarding network (20).

6. The procedure according to claim 5 characterised by that the unique transaction identifying data member (11b) is forwarded to the buyer's IT device (31) situated at the buyer (30) with the help of the information forwarding network (20).

7. The procedure according to any of claims 1-4 characterised by that the unique transaction identifying data member (11b) is brought to the knowledge of the buyer (30) directly.

8. The procedure according to any of claims 1-7 characterised by that the transaction identifying data member (11b) is set in an identifying data file (11a), and an individual transaction identifying data member (11b) of the identifying data file (11a) is linked to every individual business transaction.

9. The procedure according to any of claims 1-8 characterised by that that the mediation unit (60) belonging to the buyer (30) is the bank operating the buyer's (30) financial unit (61).

10. The procedure according to any of claims 1-8 characterised by that the mediation unit (70) belonging to the seller (10) is the bank operating the seller's (10) financial unit (71).

11. The procedure according to any of claims 1-10 characterised by that the mediation unit (60) belonging to the buyer (30) and the mediation unit (70) belonging to the seller (10) are one and the same bank.

12. The procedure according to any of claims 1-8 characterised by that the mediation unit (60) belonging to the buyer (30) and the mediation unit (70) belonging to the seller (10) are the same public utility service provider.

13. The procedure according to claim 12 characterised by that the financial unit (61) belonging to the buyer (30) and the financial unit (11) belonging to the seller (10) are both operated by the same public utility service provider.
